(19) United States
(12) Patent Application Publication
(10) Pub. No.: US 2022/0043388 A1
(43) Pub. Date: Feb. 10, 2022

(54) TONER HOPPER HEATING DEVICE

(71) Applicant: Hewlett-Packard Development Company, L.P., Spring, TX (US)

(72) Inventor: Donald J. Fasen, Boise, ID (US)

(73) Assignee: Hewlett-Packard Development Company, L.P., Spring, TX (US)

(21) Appl. No.: 17/294,534

(22) PCT Filed: Apr. 30, 2019
(86) PCT No.: PCT/US2019/029868

§ 371 Date: May 17, 2021

(51) Int. Cl. G03G 21/12

(52) U.S. Cl. CPC G03G 21/12

(57) ABSTRACT

Example implementations relate to toner particle storage. An example toner storage device includes a toner particle hopper and a heating device coupled to the hopper to heat toner particles received at the toner particle hopper to compress the toner particles.

### BACKGROUND

Printing devices, such as printers, copiers, etc., may be used to form markings on a physical medium, such as text, images, etc. In some examples, printing devices may form markings on the physical medium by performing a print job. A print job can include forming markings such as text and/or images by transferring print materials to the physical medium.

### BRIEF DESCRIPTION OF THE DRAWINGS

FIG. 1 illustrates a device for heating toner particles of a toner particle hopper according to an example;

FIG. 2 illustrates another device for heating toner particles of a toner particle hopper including a heating device and a controller;

FIG. 3 illustrates yet another device for heating toner particles of a toner particle hopper including a plurality of heating devices and a controller;

FIG. 4 illustrates a system for heating toner particles of a toner particle hopper including a processor and a non-transitory machine-readable medium (MRM);

FIG. 5 illustrates a diagram of a controller including a processor, a memory resource, and engines according to an example; and

FIG. 6 illustrates a method for heating toner particles of a toner particle hopper according to an example.

### DETAILED DESCRIPTION

Printing devices may include a supply of a toner comprising toner particles located in a hopper (e.g., reservoir). As used herein, the terms “toner” and “toner particles” refer to a substance which, when applied to a medium, can form representation(s) on the medium during a print job. For example, toner particles can include a toner material, a powdered semi-crystalline thermoplastic material, a powdered metal material, a powdered plastic material, a powdered composite material, a powdered ceramic material, a powdered glass material, a powdered resin material, and/or a powdered polymer material, among other types of powdered or particulate material. The toner particles can be fused when deposited to complete a print job. The toner particles can be deposited onto a physical medium. As used herein, the term “printing device” refers to any hardware device with functionalities to physically produce representation(s) on the medium. An example printing device that uses toner particles is a laser printing device (e.g., stand-alone or combination printer/scanner/copier, etc.), but examples of the present disclosure are not limited to laser printing devices.

A printing device using toner particles (e.g., dry toner particles) produces waste toner particles (e.g., following print job completion) that are stored in a waste toner particle hopper different than the hopper storing the fresh toner particles. The waste toner particles are stored in the waste toner particle hopper until the waste toner particle hopper is replaced or emptied.

Removal or replacement of the waste toner particle hopper can be very messy, as the waste toner particles are fine and can create a cloud of waste toner particle mess. The particles may also leak out of a storage container if inverted or opened. Because of that, the waste toner particle hopper may comprise a special recyclable or disposable container. In addition, while some waste toner particle hoppers may be replaceable, others may not, resulting in an end-of-life for a printing device if the waste toner particle hopper becomes full.

Some other approaches to storing waste toner particles include heating the waste toner particles prior to moving them to the waste toner particle hopper, Such approaches can result in clogging inside a printing device; in particular clogging can occur in an extruder (or heating element near the extruder) used to move the heated waste toner particles.

In contrast, examples of the present disclosure provide for increasing a capacity of a waste toner particle hopper by heating the waste toner particles after they have reached the waste toner particle hopper to decrease the air gaps between the waste toner particles and reduce the volume consumed by the waste toner particles. By compressing the waste toner particles using a heating device in the waste toner particle hopper, the amount of waste toner particles allowed in the waste toner particle hopper is increased. This can reduce the replacement frequency of the waste toner particle hopper and increase the life of the waste toner particle hopper and/or printing device. Because the waste toner particles enter the waste toner particle hopper in their particulate form (and heated after entrance), clogging can be reduced. In some examples, waste toner particle mess can be reduced, as the waste toner particles remain compressed in the waste toner particle hopper following heating, so the waste toner particles are in a more solid block format. This more solid block format can be removed and/or recycled without the mess of fine waste toner particles. In addition, the more solid format may not leak from a storage container.

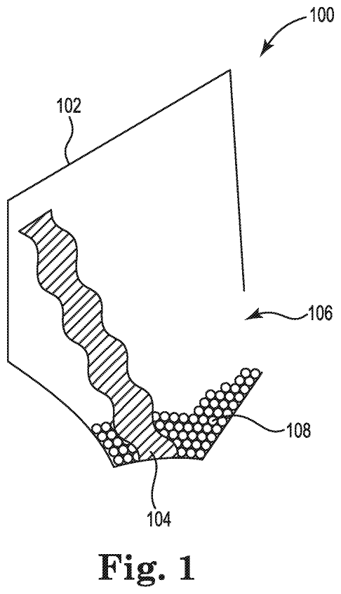

FIG. 1 illustrates a device for heating toner particles 108 of a toner particle hopper 102 according to an example. The device can be within a printing device, for instance. In some examples, the device can include a toner storage device 100 including a toner particle hopper 102, such as a waste toner particle hopper. Within the toner particle hopper 102 can be a heating device 104 (e.g., a nichrome wire arrangement) to heat the toner particles 108 reached at the toner particle hopper 102 to compress the toner particles 108. The toner particles 108, can be received at the toner particle hopper 102, for instance, at area 106.

The toner particle hopper 102 can be located in different areas of a printing device. For instance, in some examples, the toner particle hopper 102 is part of a toner cartridge of a printing device or part of a separate toner bin in the printing device. In other examples, the toner particle hopper 102 is part of an intermediate transfer belt (ITB) of the printing device. For instance, having a toner particle hopper 102, particularly a waste toner particle hopper within the ITB can reduce the size of a printing device, as extra space for the toner particle hopper 102 may be avoided.

Upon receipt of the toner particles 108 (illustrated in FIG. 1 in the particulate state), the heating device 104 can be energized (e.g., turned on, heated up, etc.) to compress the toner particles 108. Toner particles 108 may be received, for instance, subsequent to a cleaning of an organic photo conductor (OPC) of the printing device. The heating device 104 may be mounted vertically or at a slope such that toner particles 108 are heated after falling to the bottom of the toner particle hopper 102. This can reduce clogging in the toner particle hopper 102, in some examples.

In some instances, the heating device 104 can be energized periodically. In such an example, the heating device 104 may be energized following a print job completion or after a particular time period has passed, among others. In some instances, periodic energizing includes energizing the heating device 104 when other elements are not in use (e.g., a fuser heating device), to avoid increasing a peak power consumption of the printing device.

Heat may be applied by the heating device 104 to the toner particles 108 until a threshold amount of heat has been applied. For instance, the toner particles 108 may be heated to approximately a glass transition temperature. Doing so may soften and compress the toner particles 108 without melting them. Following heating/compression, the toner particles 108 may become a more solid block of toner particle material. The compressed toner particles take up a smaller space within the toner particle hopper 102 as compared to the loose, fluffy particulate form of the toner particles 108.

As used herein, “approximately” can include a value within a particular margin, range, and/or threshold. For instance, heating to approximately a glass transition temperature may include heating the toner particles 108 to a temperature within a threshold above or below the glass transition temperature. In some examples, the threshold amount of heat applied is a value other than an approximate glass transition temperature,

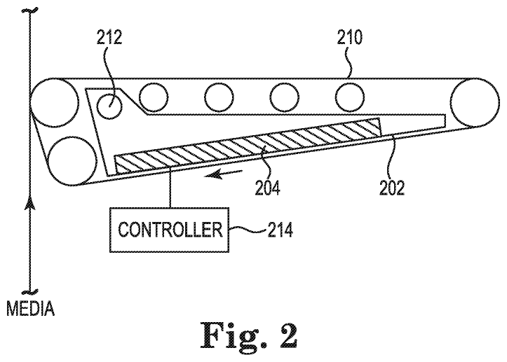

FIG. 2 illustrates another device for heating toner particles of a toner particle hopper 202 including a heating device 204 and a controller 214, The device can be within a printing device, for instance. In the example illustrated in FIG. 2, the toner particle hopper 202 is a waste toner particle hopper that is part of (e.g., within) an ITB 210. An ITB, as used herein, includes a belt that passes in front of toner cartridges within the printing device, and during a print job, each toner layer is applied to the belt. The combined layers are then applied to the media in a uniform single step. By housing the toner particle hopper 202 within the ITB 210, the printing device may be smaller because extra space for a waste toner particle hopper is avoided. The left-facing arrow indicates the direction of the belt movement, and the upward-facing arrow indicates the direction of print media movement.

Waste toner particles can enter the toner particle hopper 202 at opening 212. The controller 214 can be communicatively coupled to the heating device 204 to energize the heating device 204 to a threshold level responsive to a threshold amount of waste toner particles received at the toner particle hopper 202 to compress the threshold amount of waste toner particles. As used herein, “communicatively coupled” can include coupled via various wired and/or wireless connections between devices such that data can be transferred in various directions between the devices. The coupling need not be a direct connection, and in some examples, can be an indirect connection.

The controller 214, for instance, can include a device such as a semi-conductor device to control alternating current (AC) into a resistor (e.g., the heating device 204) such as a triode for alternating current (TRIAC) device controlled by a processor, or can include a processor in communication with a memory resource including executable instructions to control energizing of the heating device 204, among other example controllers.

The heating device 204 can be mounted at a slope within the toner particle hopper 202, as illustrated in FIG. 2, or can be mounted approximately vertically within the toner particle hopper 202. Such mounting configurations for the heating device 204 can be used to reduce clogging of waste toner particles within the toner particle hopper 202. Other heating device mounting configurations that reduce clogging may be used.

Energizing the heating device 204 to the threshold level can include, for instance, energizing the heating device 204 to approximately a glass transition temperature. The energizing, for instance, can be performed when a threshold amount of waste toner particles is received at the toner particle hopper 202. For instance, the heating device 204 can be energized following completion of a print job, which the controller 214 may recognize as a certain weight, height, or amount of waster toner particles in the toner particle hopper 202. In other examples, the heating device 204 can be energized responsive to cleaning of the OPC. In some examples, a sensor may be used to determine the threshold amount of waste toner particles or completion of a print job in the toner particle hopper 202 but may not be used in some examples to reduce costs. In some instances, the heating device 204 is energized by the controller 214 at a time other than when a print job fusion heating device is energized to reduce peak power consumption of the printing device.

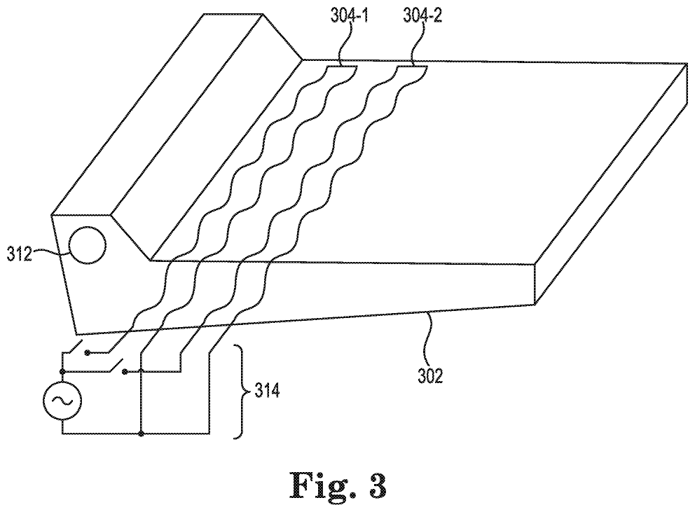

FIG. 3 illustrates yet another device for heating toner particles of a toner particle hopper 302 including a plurality of heating devices 304-1, 304-2 (herein after referred to collectively as heating devices 304) and a controller 314. In the example illustrated in FIG. 3, the toner particle hopper 302 is a waste toner particle hopper that is part of (e.g., within) an ITB such as ITB 210 illustrated in FIG. 2.

The controller 314 can include a device such as a semi-conductor device to control AC into a resistor (e.g., the heating devices 304) such as a TRIAC device illustrated in FIG. 3. In some examples, the controller 314 may be a processor in communication with a memory resource including executable instructions to control energizing of the heating devices 304, among other example controllers.

Toner particles such as waste toner particles can enter the toner particle hopper 302 at opening 312. As the toner particles enter the toner particle hopper 302, the heating devices 304 can be periodically energized (e.g., via the controller 314). The heating devices 304 can be energized based on the amount of toner particles in the toner particle hopper 302. For instance, toner particles entering at opening 312 may settle near the heating device 304-1 because of gravity (e.g., the toner particle hopper 302 is sloped toward the heating device 304-1). When the toner particles are falling into that area, the heating device 304-1 may be energized to heat the toner particles. As the toner particle hopper 302 fills, and the toner particles reach the area of the heating device 304-2, the heating device 304-2 may be energized to heat the toner particles.

In such an example, determining which of the heating devices 304 to energize can be done based on a printed page count. For instance, based on the printed page count, a determination can be made regarding the amount of waste toner particles entering the toner particle hopper 302. In some examples, a sensor could be used to make the determination. When a determination is made to switch from the first heating device 304-1 to the second heating device 304-2, the second heating device 304-2 is energized, and the first heating device 304-1 is turned off. While two heating devices 304 are illustrated in FIG. 3, more or fewer may be present in the toner particle hopper 302.

In some examples, as the toner particles are heated and form a more solid block, the heating devices 304 may be engulfed in the heated toner particles. For instance, as the toner particles completely cover the heating device 304-1, the heating device 304-1 can be enveloped by the heated toner particles and recycled with the waste toner upon removal/recycling of the toner particle hopper 302. While a toner particle hopper 302 is illustrated in an ITB in FIG. 3, a toner particle hopper having a plurality of heating devices therein may be part of a printing device cartridge or other printing device component.

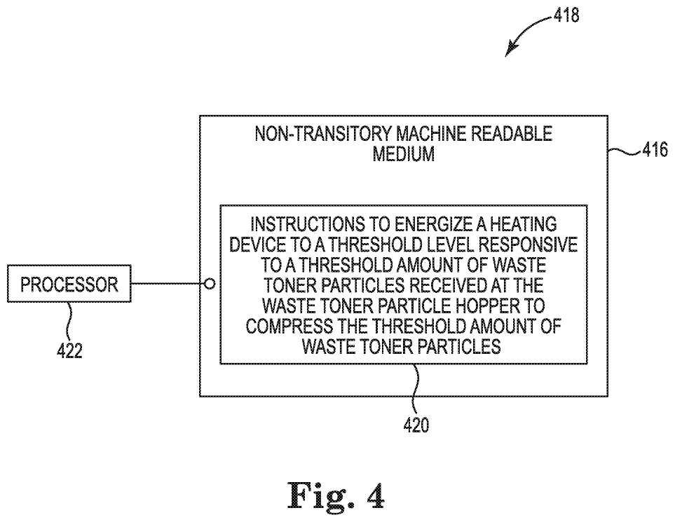

FIG. 4 illustrates a system 418 for heating toner particles of a toner particle hopper including a processor 422 and a non-transitory machine-readable medium (MRM) 416. System 418 can be a computing device in some examples and can include a processor 422. System 418 can further include a non-transitory MRM 416, on which may be stored instructions, such as instructions 420. Although the following descriptions refer to a processor and a memory resource, the descriptions may also apply to a system with multiple processors and multiple memory resources. In such examples, the instructions may be distributed (e.g., stored) across multiple non-transitory MRMs and the instructions may be distributed (e.g., executed by) across multiple processors.

The non-transitory MRM 416 may be electronic, magnetic, optical, or other physical storage device that stores executable instructions. Thus, non-transitory MRM 416 may be, for example, Random Access Memory (RAM), an Electrically-Erasable Programmable ROM (EEPROM), a storage drive, an optical disc, and the like. The non-transitory MRM 416 may be disposed within a printing device. In this example, the executable instructions 420 can be “installed” on the device. Additionally and/or alternatively, the non-transitory MRM 416 can be a portable, external or remote storage medium, for example, that allows the system 418 to download the instructions 420 from the portable/external/remote storage medium. In this situation, the executable instructions may be part of an “installation package”. As described herein, the non-transitory MRM 416 can be encoded with executable instructions for vulnerability state report creation.

The instructions 420, when executed by a processor such as the processor 422, can include instructions to energize a heating device to a threshold level responsive to a threshold amount of waste toner particles received at the waste toner particle hopper to compress the threshold amount of waste toner particles. For instance, a heating device within a waste toner particle hopper can be heated to a particular temperature when a particular amount of waste toner particles enters the waste toner particle hopper. The particular temperature, for instance, can be a temperature that causes a desired phase change of the waste toner particles (e.g., from a fine particle to a more solid or soft-solid material). The particular amount can be a certain physical level within the waste toner particle hopper (e.g., a certain height within the waste toner particle hopper) or an amount of waste toner particles that enter the waste toner particle hopper upon completion of a print job. In some examples, a plurality of heating devices is energized (e.g., separately or together), The heating device or devices can include heating wires, heating coils, or a nichrome wire arrangement, among others. The same or different heating devices may be present when a plurality of heating devices is used.

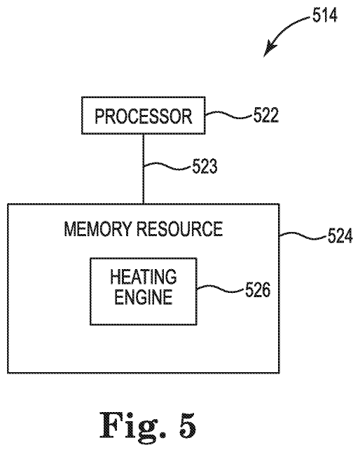

FIG. 5 illustrates a diagram of a controller 514 including a processor 522, a memory resource 524, and engine 526 according to an example. For instance, the controller 514 can be a combination of hardware and instructions for heating waste toner particles in a waste toner hopper. The hardware, for example can include the processor 522 and/or the memory resource 524 (e.g., MRM, computer-readable medium (CRM), data store, etc.).

The processor 522, as used herein, can include a number of processing resources capable of executing instructions stored by the memory resource 524. The instructions (e.g., machine-readable instructions (MRI)) can include instructions stored on the memory resource 524 and executable by the processor 522 to implement a desired function (e.g., heating waste toner particles in a waste toner hopper). The memory resource 524, as used herein, can include a number of memory components capable of storing non-transitory instructions that can be executed by the processor 522. The memory resource 524 can be integrated in a single device or distributed across multiple devices. Further, the memory resource 524 can be fully or partially integrated in the same device as the processor 522 or it can be separate but accessible to that device and processor 522. Thus, it is noted that the controller 514 can be implemented on an electronic device and/or a collection of electronic devices, among other possibilities.

The memory resource 524 can be in communication with the processor 522 via a communication link (e.g., path) 523. The communication link 523 can be local or remote to an electronic device associated with the processor 522. The memory resource 524 includes engines (e.g., heating engine 526). The memory resource 524 can include more engines than illustrated to perform the various functions described herein.

The engine 526 can include a combination of hardware and instructions to perform a number of functions described herein (e.g., heating waste toner particles in a waste toner hopper). The instructions (e.g., software, firmware, etc.) can be downloaded and stored in a memory resource (e.g., MRM) as well as a hard-wired program (e.g., logic), among other possibilities.

The heating engine 526 can energize a heating device to heat waste toner particles received at a waste toner particle hopper to compress the waste toner particles. The capacity of the waste toner particle hopper can be increased by heating the waste toner particles to decrease air gaps between the toner particles (e.g., reducing volume consumed by the waste toner particles). By increasing the capacity of the waste toner particle hopper, the life of the waste toner particle hopper is extended, which decreases replacement frequency if the waste toner particle hopper is replaceable or increases the printing device lifetime if the waste toner particle hopper is not replaceable. Such an example can also reduce downtime due to time used to replace the waste toner particle hopper or the printing device.

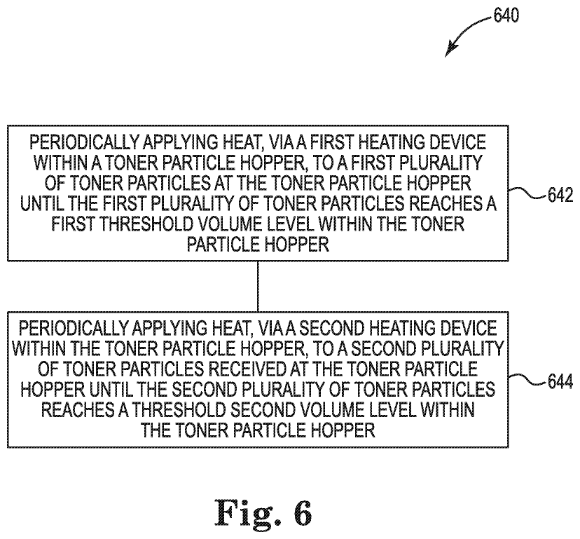

FIG. 6 illustrates a method 640 for heating toner particles of a toner particle hopper according to an example. Method 640 may be performed by a system 418 and/or controllers 214, 314, and 514 as described with respect to FIGS. 2-5, In some instances, system 418 and/or controllers 214, 314, and 514 may be located on a printing device.

The method 640 can include the use of a plurality of heating devices that can be energized based on a level of toner particles (e.g., waste toner particles) within a toner particle hopper (e.g., a waste toner particle hopper). The method 640 can allow for reduce power consumption, as smaller heating devices can be used. As a heating device is consumed or its level surpassed by heated toner particles, the next heating device can be energized to heat subsequently received toner particles.

At 642, the method 640 includes periodically applying heat, via a first heating device within a toner particle hopper, to a first plurality of toner particles received at the toner particle hopper until the first plurality of toner particles reaches a first threshold volume level within the toner particle hopper. The heat, for instance, can be periodically applied for a plurality of print jobs (e.g., at each print job completion) until the first plurality of toner particles reaches the first threshold volume level within the toner particle hopper. The first threshold volume, for instance, can include reaching the end of the first heating device, or a toner particle volume left after a particular number of completed print jobs. In some examples, the heat is applied to approximately a glass transition temperature. Application of the heat via the first heating device can be ceased responsive to the first plurality of toner particles reaching the first threshold volume level within the toner particle hopper.

At 644, the method 640 includes periodically applying heat, via a second heating device within the toner particle hopper, to a second plurality of toner particles received at the toner particle hopper until the second plurality of toner particles reaches a threshold second volume level within the toner particle hopper. The heat, for instance, can be periodically applied for a plurality of print jobs (e.g., at each print job completion) until the second plurality of toner particles reaches the second threshold volume level within the toner particle hopper. The second threshold volume, for instance, can include reaching the end of the second heating device, or a toner particle volume left after a particular number of completed print jobs. In some examples, the heat is applied to approximately a glass transition temperature. Application of the heat via the second heating device can be ceased responsive to the second plurality of toner particles reaching the second threshold volume level within the toner particle hopper. While two heating devices are described with respect to the method 640, more or less than two heating devices may be used in some examples.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Further, as used herein, “a number of” an element and/or feature may refer to one or more of such elements and/or features.

What is claimed is:

1. A toner storage device comprising:
a toner particle hopper; and
a heating device coupled to the hopper to heat toner particles received at the toner particle hopper to compress the toner particles.

2. The device of claim 1, wherein the toner particle hopper is part of a toner cartridge of a printing device.

3. The device of claim 1, wherein the toner particle hopper is part of an intermediate transfer belt of a printing device.

4. The device of claim 1, wherein the heating device is energized periodically to compress the toner particles.

5. The device of claim 1, further comprising the heating device heating the toner particles until a threshold amount of heat has been applied to the toner particles.

6. The device of claim 1, wherein the toner hopper is a waste toner hopper.

7. A system, comprising:
a waste toner particle hopper having a heating device housed therein; and
a controller communicatively coupled to the heating device to:
energize the heating device to a threshold level responsive to a threshold amount of waste toner particles received at the waste toner particle hopper to compress the threshold amount of waste toner particles.

8. The system of claim 7, wherein the heating device is mounted approximately vertically within the waste toner particle hopper.

9. The system of claim 7, wherein the heating device is mounted at a slope within the waste toner particle hopper.

10. The system of claim 7, further comprising the controller to energize the heating device responsive to completion of a print job.

11. The system of claim 7, further comprising the controller to energize the heating device at a time other than when a print job fusion heating device is energized.

12. A method for waste toner storage, comprising:
periodically applying heat, via a first heating device within a toner particle hopper, to a first plurality of toner particles received at the toner particle hopper until the first plurality of toner particles reaches a first threshold volume level within the toner particle hopper; and
periodically applying heat, via a second heating device within the toner particle hopper, to a second plurality of toner particles received at the toner particle hopper until the second plurality of toner particles reaches a threshold second volume level within the toner particle hopper.

13. The method of claim 12, further comprising:
periodically applying heat via the first heating device responsive to print job completions until the first plurality of toner particles reaches the first threshold volume level within the toner particle hopper; and
periodically applying heat via the second heating device responsive to print job completions until the second plurality of toner particles reaches the second threshold volume level within the toner particle hopper.

14. The method of claim 12, further comprising ceasing application of heat via the first heating device responsive to the first plurality of toner particles reaching the first threshold volume level within the toner particle hopper.

15. The method of claim 12, wherein periodically applying heat to the first plurality of toner particles comprises periodically applying heat to approximately a glass transition temperature of the first plurality of toner particles.
